(19) United States
(12) Patent Application Publication
(10) Pub. No.: US 2007/0195516 A1
(43) Pub. Date: Aug. 23, 2007

(54) Decorative bulb chain

(76) Inventor: Chung Wai Cheng, Kowloon Bay (HK)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/361,014

(22) Filed: Feb. 23, 2006

(30) Foreign Application Priority Data
Feb. 20, 2006 (CN) 200620003704.5

(51) Int. Cl. F21S 6/00

(52) U.S. Cl. 362/123; 362/249; 362/252

(57) ABSTRACT

A decorative bulb chain including a plurality of bulb chain units, which can be connected one another electrically in a detachable manner, is provided. Various shapes of the tree branches can be realized by connecting the respective bulb chain units in series, in parallel, or in combination thereof, or by way of false threads. The mounting and removal of the decorative bulb chain of the present invention are very easy, and wire tangling easily avoided.

### CROSS-REFERENCE TO RELATED APPLICATION(S)

This application claims priority to Chinese Application No. ______, filed on Feb. 20, 2006, the contents of which are incorporated in its entirety by reference herein.

### FIELD OF THE INVENTION

The present invention relates to a decorative bulb chain. More particularly, the present invention relates to a decorative bulb chain that can be arranged easily on a tree, such as a Christmas tree, which has the shape of tree branches.

### BACKGROUND OF THE INVENTION

Decorative bulb chains are used widely during holidays and celebrations to enhance the festival atmosphere. For example, during the Christmas holiday season, the decorative bulb chain has become one of the indispensable decoration items. Generally, the decorative bulb chains are first wound on the tree branches or the other suitable positions, then they are fixed on the tree branches. However, it may take a long time to hang the decorative bulb chains, and sometimes it may also cause tangling of the wires. Similarly, it is a time consuming process to take down the bulb chains afterwards. Also, it is desirable to make the profile of an entire tree be more easily configured or arranged. As such, it is desirable that the length of the bulb chains is extended, thereby increasing the cost significantly.

To this end, brackets for fixing the decorative bulb chains have been proposed in the prior art. For example, “A tree-shaped lighting device” was disclosed in the Chinese Utility Model Patent No. CN 2403991Y. The tree-shaped lighting device comprises upper and lower support rings which are co-axial, wherein the diameter of the upper support ring is smaller than that of the lower support ring, and a central post is disposed between the upper support ring and the lower support ring, the bulb chain consisting of electrical wires and bulbs extends repeatedly and cyclically between the upper support ring and the lower support ring, and a tree-shaped decorative bulb device is formed by supporting the bulb chain via the upper support ring and lower support ring. However, since the bulb chain extends repeatedly and cyclically between the upper support ring and the lower support ring, on one hand, the mounting is rather complicated, easily causing the wires to be in disorder. On the other hand, when operation failure due to wire disconnection occurs somewhere in the circuit, it is difficult to find the failure point, so that the maintenance is very inconvenient.

Further, for example, “A tree-branch-shaped lighting structure” was disclosed in the Chinese Utility Model Patent No. CN 2568913Y, which comprises a trunk, branches and bulb chain sets, wherein the trunk and the branches are used as their brackets for the bulb chain sets, and to exhibit a special form of the bulb chain combination, several chain sets were winded on the respective tree branches, while the bulb chain sets extending at the tilted direction are incorporated on the tree branches to form a fancy tree-branch-lighting as a whole. However, because the bulb chain is wound on the respective tree branches, and the bulb chain has several branch sets, so the wire of the bulb chain is very long, and the structure is complicated, that is, it has to be wound round and round, thus, the waste of the wire of the bulb chain is serious, resulting in significant cost increase. Even if it is not roundabout, there are many connection points due to connecting in series or in parallel between the respective bulb chains, the arrangement is time consuming, the removal is bothersome, and the factors of insecurity increase significantly.

### SUMMARY OF THE INVENTION

The present invention overcomes the above disadvantages in the prior art and provides a decorative bulb chain which can be arranged conveniently on Christmas trees or any other suitable suspending positions, whereby wires tangling is prevented, and the bulb chain can also be conveniently decorated and removed.

In one embodiment of the present invention, a decorative bulb chain comprises a plurality of bulb chain units, and the respective bulb chain units may be connected electrically in a detachable manner.

Further in one embodiment, the respective bulb chain units are configured and arranged in tree-branch-shaped units. The respective tree-branch-shaped bulb chain units have different sizes.

The above tree-branch-shaped bulb chain unit is formed by connecting a plurality of bulbs in series, in parallel, or in combination thereof. Furthermore, if necessary, the shape of tree branch can also be formed by means of false threads in the bulb chain unit.

Furthermore, the detachable electrical connections between the plurality of bulb chain units are implemented by inserting plugs into sockets. Specifically, one end of each of the bulb chain units is equipped with a plug, and the other end is equipped with a socket. Alternatively, one end of each of the bulb chain units is equipped with a multi-function connector, which has both functions of a plug and a socket.

The decorative bulb chain according to the present invention is divided into a plurality of bulb chain units, and the shape of tree branch is formed by connecting the respective bulb chain units in series, in parallel, or in combination thereof, or by using false threads so that the arrangement and removal of the decorative bulb chains according to the present invention are extremely convenient, the time for arranging the decorative bulb chains can be shortened effectively, and the cost can be reduced simultaneously. Furthermore, when arranging the decorative bulb chains according to the present invention on the tree branches, the respective disadvantages due to tangling the bulb chains to the tree branches in the prior art can be prevented. The decorative bulb chains can be jointed directly on the branches and seized properly.

### BRIEF DESCRIPTION OF THE DRAWINGS

The drawings, which are part of the present invention, illustrate the preferred embodiment of the present invention.

FIG. 1 is a structural schematic diagram of a bulb chain unit of the decorative bulb chain according to the present invention;

FIG. 2 is another structural schematic diagram of a bulb chain unit of the decorative bulb chain according to the present invention; and

FIG. 3 is a structural schematic diagram of the decorative bulb chains according to the present invention after being arranged on the Christmas tree.

### DETAILED DESCRIPTIONS OF THE PREFERRED EMBODIMENT

The preferred embodiment of the present invention will be described in detail by referring to the drawings as follows.

It is easy to be understood that the decorative bulb chains according to the present invention can be used in a variety of situations where an atmosphere of excitement is required, for example, the doorway of a store, and indoor decoration, and the like. For the convenience of explanation, use of the decorative bulb chains for a Christmas tree decoration is taken as an example to describe the present embodiment.

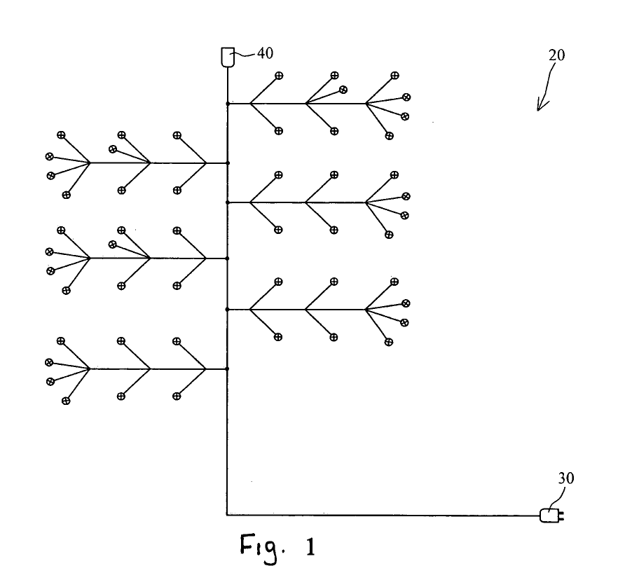

A novel decorative bulb chain 10 according to the present invention comprises a plurality of bulb chain units 20. A structural schematic diagram of bulb chain units 20 is shown in FIG. 1. As shown, the bulb chain units 20 are connected in series, in parallel, or in the combination thereof to form the shapes of the tree branches. Those skilled in the art can implement easily the shapes of the tree branches by connecting the above bulb chain units 20 in series, in parallel, in the combination thereof. Therefore, in the embodiment, the detail description thereof will be omitted. Furthermore, in order to implement the shapes of the tree branches by using the above bulb chain units 20, false threads can be used in the bulb chain units 20 as auxiliaries, wherein the false threads are non-conductive threads, they are not used for electrically connecting the respective bulbs, but only used for twining the conductive wires to reinforce the shapes or to assist in implementing the shapes of the bulb chain units 20. The false thread comprises normally an inner core fabricated by insulation material and an outer envelope fabricated by insulation material for wrapping the inner core.

Furthermore, one end of the bulb chain unit 20 is connected to a plug 30, the other end to a socket 40.

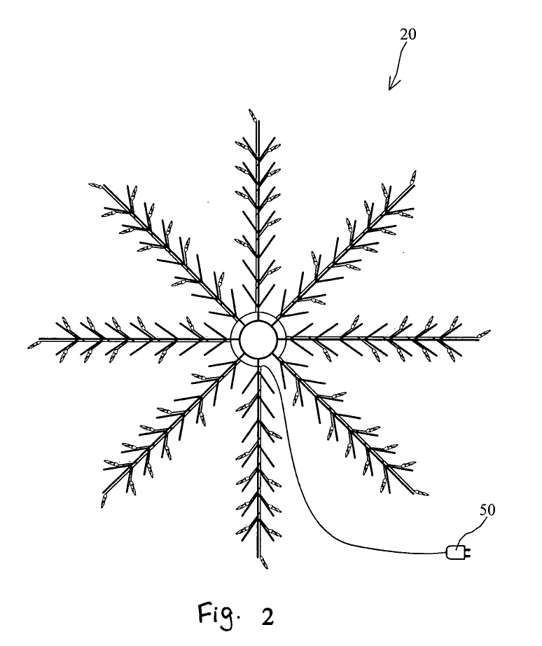

Another structural schematic diagram of the bulb chain units 20 of the novel decorative bulb chain 10 according to the present invention is shown in FIG. 2. The bulb chain unit 20 having the shapes of the tree branches is shown similarly in FIG. 2, and similarly, the shapes of the tree branches are formed by connecting the respective bulbs in series, in parallel, or in combination thereof, or are implemented by means of false threads. The method for connecting the bulb chain units 20 to form the shape of tree branches is not critical.

Furthermore, one end of the bulb chain unit 20 shown in FIG. 2 is connected to a multifunction connector 50 which functions both as a plug and a socket, that is, the multifunction connector 50 can be plugged into another multifunction connector 50 or into other normal socket. Meanwhile, other multifunction connector 50 or normal plug can also be plugged into said multifunction connector 50. The use of the multifunction connector 50 simplifies the structure for connecting the bulb chain units 20.

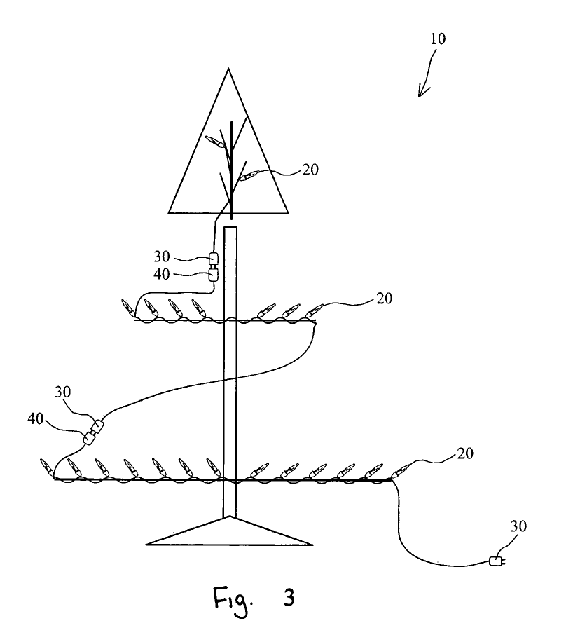

FIG. 3 is a structural schematic diagram of the decorative bulb chain according to the present invention after being arranged on a Christmas tree. Three bulb chain units 20 as shown in FIG. 1 or FIG. 2 are shown in FIG. 3, and the sizes of the three bulb chain units 20 are different, the largest bulb chain unit 20 is arranged at the lowest part of the Christmas tree, and the smallest bulb chain unit 20 is arranged at the highest part of the Christmas tree. Furthermore, as shown in the drawing, the plug 30 at one end of the highest bulb chain unit 20 is plugged into the socket 40 at one end of the middle bulb chain unit 20, and the plug 30 of another end of the middle bulb chain unit 20 is plugged into the socket 40 at one end of the lowest bulb chain unit 20, and the socket 30 at another end of the lowest bulb chain unit 20 can be fetched out so as to plug to, such as a power supply, for supplying the electricity energy to the decorative bulb chain 10.

A decorative bulb chain 10 comprising only three bulb chain units 20 is shown exemplarily in FIG. 3. Of course, it is to be understood that the decorative bulb chain 10 can include any number of the bulb chain units 20. And the respective bulb chain units 20 can be connected optionally by using the plugs 30, the sockets 40, or the multifunction connectors 50 having both the functions of the plug and the socket arranged thereon, thereby the decoration of the Christmas tree can be implemented.

The decorative bulb chain 10 according to the present invention comprises a plurality of bulb chain units 20, and the respective bulb chain units 20 are no longer to be twined on the tree branches, while the respective bulb chain units 20 themselves are connected as the shapes of the tree branches, and attached correspondingly to the branches of the Christmas tree respectively, and then they are fixed by using strap or retainer. The respective bulb chain units 20 can be arranged in hierarchy, and the bulb chain units on each layer can be connected electrically via the connections of the plugs and the sockets. In this way, not only the arrangement of the decorative bulb chain 10 is very easy, the problem of tangling of the bulb wires is avoided, but also a Christmas tree having beautiful and tidy shape can be implemented. Furthermore, after using the decorative bulb chain 10, the decorative bulb chain 10 is easy to be removed and collected by removing the respective bulb chain units 20 and disconnecting the electrical connections between the respective bulb chain units 20 respectively.

The above description only illustrates the preferred embodiment of the present invention rather than a limitation to the present invention. For those skilled in the art, various modifications and changes of the present invention are possible. Any modifications, equivalent substitutions, and improvements made by using metal plate to connect with the wire in parallel, and the like, are included within the protection scope of the present invention.

What is claimed is:

1. A decorative bulb chain, comprising a plurality of bulb chain units, wherein the bulb chain units are detachably connected one another electrically.

2. The decorative bulb chain of claim 1 wherein said bulb chain units are tree-branch-shaped bulb chain units.

3. The decorative bulb chain of claim 2 wherein the tree-branch-shaped bulb chain units each has a different size.

4. The decorative bulb chain of claim 2 wherein the tree-branch-shaped bulb chain unit is formed by connecting a plurality of bulbs in series, in parallel, or in combination thereof.

5. The decorative bulb chain of claim 2 wherein the tree-branch-shaped bulb chain unit is formed by using false threads.

6. The decorative bulb chain of claim 1 wherein the detachable electrical connection between said plurality of bulb chain units is realized by inserting a plug into a socket.

7. The decorative bulb chain of claim 6 wherein one end of each of the bulb chain units is provided with a plug, and the other end, a socket.

8. The decorative bulb chain of claim 6 wherein one end of each of the bulb chain units is provided with a multi-function connector which acts both as a plug and a socket.
